(19) United States
(12) Patent Application Publication
(10) Pub. No.: US 2006/0224897 A1
(43) Pub. Date: Oct. 5, 2006

(54) Access control service and control server

(76) Inventors: Satoshi Kikuchi, Yokohama (JP); Takashi Tsunehiro, Ebina (JP); Emiko Kobayashi, Yokohama (JP); Toui Miyawaki, Kawasaki (JP)

Correspondence Address: MCDERMOTT WILL & EMERY LLP, 600 13TH STREET, N.W., WASHINGTON, DC, 20005-3096, US

(21) Appl. No.: 11/363,508

(22) Filed: Feb. 28, 2006

(30) Foreign Application Priority Data
Apr. 1, 2005 (JP) 2005-105835
Oct. 11, 2005 (JP) 2005-296167

(51) Int. Cl. G06F 12/14; H04L 9/00; G06F 17/30; H04L 9/32; H04K 1/00; G06F 12/00; G06F 13/00; G06F 7/04; G06F 7/58; G06K 19/00; G11C 7/00

(52) U.S. Cl. 713/182; 726/17; 726/18

(57) ABSTRACT

To provide an access control service and control server for protecting a computer from an Illegal access such as a password cracking, in a terminal service and other related services. An access server 3 includes an authentication manager 7 for authenticating a user to operate a terminal, and an ACE manager 9 for setting a network link that enables communication between a terminal 1 that the user operates and a specific computer unit 2, to a hub 4 in accordance with a result of the authentication. Information on each user and information on the specific computer unit 2 that the each user can use are associated with each other and registered in the ACE manager 9.

### INCORPORATION BY REFERENCE

This application claims priority based on Japanese patent applications, No. 2005-105835 filed on Apr. 1, 2005 and No. 2005-296167 filed on Oct. 11, 2005, the entire contents of which are incorporated herein by reference.

### BACKGROUND OF THE INVENTION

The present invention relates to an access control service and control server suitable for use in a terminal service and other related services.

With the recent spread of the Internet, there is a demand for carrying out various types of jobs (hereinafter referred to as PC jobs), such as creating e-mails, Websites, and documents using a computer (PC) anywhere, away from home, at home, or in other places. In order to meet this demand, a system for carrying out PC jobs by accessing a computer at a remote site (remote computer) via a network to display a desktop window of the computer on a user's own terminal has been practically used, which is generally called as a terminal service. In this terminal service, the created data and the software such as an OS (Operating System) and application programs used for the PC jobs are all stored in a secondary storage such as a hard disk on the remote computer side, and each of the software is executed by a CPU (Central Processing Unit) of the remote computer. The user's own terminal that the user directly operates sends control information that is input from a user I/F device such as a keyboard or a mouse to the remote computer, as well as the terminal displays desktop image information sent from the remote computer on a display thereof.

There are two modes of the terminal service. The first mode is that one user exclusively owns one remote computer, which is called P2P (Peer to Peer) type or remote desktop. The second mode is that plural users shares one remote computer, which is called as (Server Based Computing) type or terminal server.

The user makes a connection request to the remote computer from his own terminal, when starting a PC job. At this time, the remote computer implements user authentication for verifying the identity, in other words, that the user is the identical user of the remote computer. As the user authentication, a method for verifying the identity by combination with a user ID and a password is widely used. The remote computer displays a login window when receiving the connection request, and compares the user ID and password that the user inputs (logs in) with the combination of the previously registered user ID and password. When these combinations are identical, the remote computer permits the connection request and provides the user's terminal with a terminal service. When these combinations are not identical, the remote computer rejects the connection request.

In light of the convenience and security for carrying out the above-described user authentication and the connection to terminal service, there has been proposed a connection method using a storage medium such as an IC card. For example, a technology described in JP-A No. 2001-282747 (referred to as Patent Document 1) attaches a storage medium (IC card) in which first information necessary for connecting the terminal to the server via the network and second information for authenticating the user are stored to the terminal, compares the information that the user has input to the second information stored in the storage medium, and automatically connects the terminal to the server using the first information read from the storage medium, when the first and second information are identical.

Further, a method for preventing an abuse of the system by an illegal user has also been proposed. For example, a technology described in U.S. Pat. No. 6,907,470 (referred to as Patent Document 2) controls the network equipment to authenticate the user in the access to a file server, relay only the packet from the terminal that the user having succeeded in the authentication operates, and discard the packets from other terminals.

### SUMMARY OF THE INVENTION

The above-described connection method to the terminal service has a problem as described below.

The user authentication method by combination with the user ID and password cannot perfectly protect the computer from a password cracking such as a brute force attack that simply attempts to use every possible alpha-numeric combination or a dictionary attack with a dictionary containing words, personal names and the like. As a result, there is a risk that another person might analyze the password, illegally accesses the computer from a remote computer and steals the data stored in the computer. Particularly, the user authentication via the network such as the terminal service is likely to suffer the password cracking because another person can attack from any place in which the network is coupled, without being seen by anyone else and without worrying about the time required.

In order to suppress the above-described password cracking, many of the general purpose OSs are provided with an account lockout function for limiting the login attempt within a certain number of times. In other words, for example, when the login has failed three times in succession, subsequently the login to the computer is disabled (in the lockout status) for a certain period of time. With the account lockout function, the login attempt can be made only a certain number of times within a set time period, which is an effective action against the password cracking that attempts to log in many times in a short period of time.

However, also in the case of the account lockout function, there is a risk of a harassing action against the right user by abusing this function. In other words, another person can prevent the right user from using the computer by continuously failing to log in to the account of the right user and bringing the computer into the lockout status on purpose. Such a harassing action can be a sort of the password cracking.

Even using the technology described in Patent Document 1, it is difficult to protect the computer from such a password cracking.

Although the password cracking by an unauthenticated anonymous user can be protected using the technology described in Patent Document 2, the authenticated right user can access the other person's remote computer, so that it is difficult to protect from the password cracking as an internal crime.

Further, various types of software that attack computers, such as a port scan attack that seeks a communication port that can be illegally entered and a Dos (Denial of Services) attack that sends a large amount of data to the computers to disable their services, can be obtained through the Internet, so that even computers within an organization have become unsafe.

The present invention provides an access control service and control server for protecting the computer from the illegal access such as the password cracking in a terminal service or other related services.

The access control service according to the present invention is characterized by including a control server for authenticating the user to operate the terminal and setting a network link that enables communication between the terminal that the user operates and a specific computer unit, in accordance with a result of the authentication. Further, the access control service is characterized in that information on each user and information on the specific computer unit that the each user can use are associated with each other and registered in the control server.

Further, the access control service according to the present invention includes: a shared storage that is coupled to each of the computer units and has an available storage area assigned to each user; and a control server for authenticating the user to operate the terminal, mounting the storage area within the storage assigned to the user in accordance with a result of the authentication to any of the computer units, and setting a network link that enables the communication between the terminal that the user operates and the mounted computer unit. In the control server, information on each user and information on the storage area within the storage that the each user can use are associated with each other and registered.

Further, the access control service according to the present invention includes: a shared storage that is coupled to each of the computer units via a network and has an available storage area assigned to each user; and a control server for authenticating the user to operate the terminal, mounting the storage area within the shared storage assigned to the user in accordance with a result of the authentication, and setting a network link that enables the communication between the terminal that the user operates and the storage. In the control server, information on each user and information on the storage area within the storage that the each user can use are associated with each other and registered.

The control server according to the present invention includes: an authentication manager for authenticating the user to operate the terminal; and a link manager for setting a network link that enables the communication between the terminal that the user operates and the specific computer unit.

Further, the control server according to the present invention includes: an authentication manager for authenticating the user to operate the terminal; a computer unit manager for mounting a storage area assigned to the user, within a shared storage coupled to each computer unit, to any of the computer units in accordance with a result of the authentication; and a link manager for setting a network link that enables the communication between the terminal that the user operates and the mounted computer unit.

Further, the control server according to the present invention includes: an authentication manager for authenticating the user to operate the terminal; a computer unit manager for mounting a storage area assigned to the user, within a shared storage coupled to each terminal via a network, to the terminal that the user operates in accordance with a result of the authentication; and a link manager for setting a network link that enables the communication between the terminal that the user operates and the storage.

The present invention makes it possible to provide an access control service that prevents illegal accesses by other than the right user to safely protect the user data.

These and other benefits are described throughout the present specification. A further understanding of the nature and advantages of the invention may be realized by reference to the remaining portions of the specification and the attached drawings.

### BRIEF DESCRIPTION OF THE DRAWINGS

FIG. 1 exemplifies a configuration of a computer system for carrying out an access control service according to a first embodiment;

FIG. 2 exemplifies the logical configuration of an access control server 3 in FIG. 1;

FIG. 3 exemplifies the contents of information that a management DB 10 stores in FIG. 2;

FIG. 4 exemplifies relay permit/deny information (ACE) that the access control server 3 of FIG. 2 sets;

FIG. 5 exemplifies communication sequences among the devices in FIG. 1;

FIG. 6 exemplifies the flowchart of a connection processing;

FIG. 7 exemplifies the flowchart of an dormancy processing;

FIG. 8 exemplifies the flowchart of a shutdown processing;

FIG. 9 illustrates the access control function in FIG. 1;

FIG. 10 exemplifies another configuration of the embodiment of FIG. 1;

FIG. 11 exemplifies a configuration of a computer system for carrying out the access control service according to the second embodiment;

FIG. 12 exemplifies the contents of information that a management DB 30 stores in FIG. 11;

FIG. 13 exemplifies the internal configuration of a terminal 1 in FIG. 1;

FIG. 14 exemplifies the internal configuration of the access control server 3 in FIG. 1;

FIG. 15 exemplifies a variant of the communication sequences of FIG. 5;

FIG. 16 exemplifies another variant of the communication sequences of FIG. 5;

FIG. 17 exemplifies a configuration of a computer system for carrying out the access control service according to a third embodiment;

FIG. 18 exemplifies the contents of information that a management DB 51 stores in FIG. 17; and

FIG. 19 exemplifies the communication sequences among the devices in FIG. 17.

### DETAILED DESCRIPTION OF THE EMBODIMENTS

Hereinafter, the embodiments of the access control service and the control server according to the present invention will be described using the accompanying drawings.

### Embodiment 1

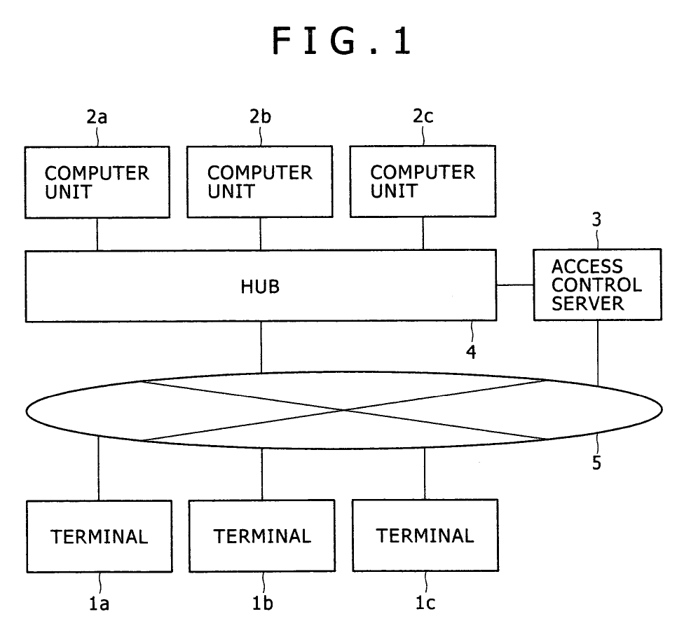

FIG. 1 is a configuration view showing a first embodiment of a computer system for carrying out the access control service according to the present invention. A network 5 such as a LAN is coupled with one or more (in this example, three) terminals 1 (1a, 1b, 1c), one or more (in this example, three) computer units 2 (2a, 2b, 2c) via a hub 4, and an access control server 3. The access control server 3 is directly coupled to an administration port of the hub 4. A user operates any of the terminals 1 to access a specific one of the computer units 2, and thereby the user is provided with a P2P-type terminal service. Herein, each of the terminals 1 and the access control server 3 may be coupled to a network 5 via a network device such as a repeater hub, a switching hub, or a switch.

Each of the computer units 2 is a remote computer including a secondary storage such as a hard disk for storing created data and software such as an OS and application programs used for jobs, a CPU for executing each software and the like.

The hub 4 is the network device including a relay function for sending the packet received from one computer to another, and a filtering function for blocking the relay other than between the above computers. A general-purpose switching hub, switch, blade and the like can be used for the hub 4.

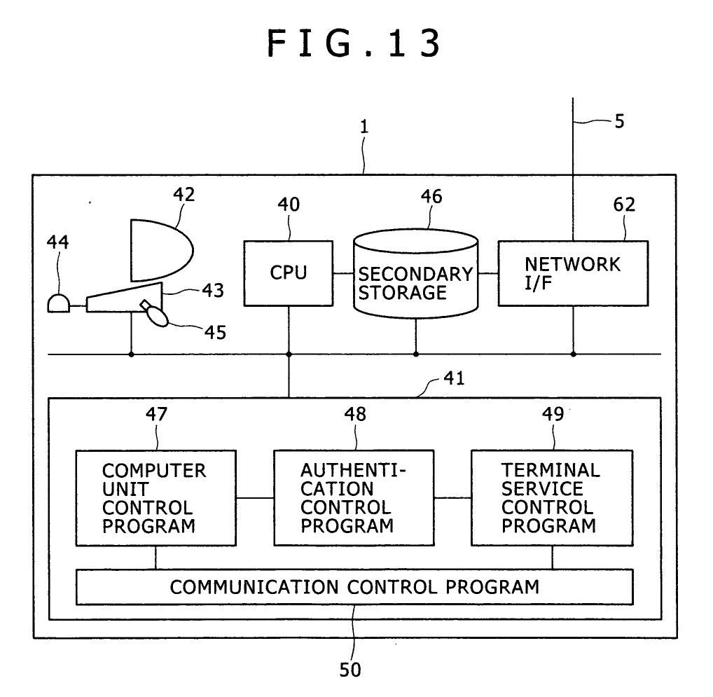

FIG. 13 is a view showing an example of the internal configuration of the terminal 1 in the embodiment.

The terminal 1 is a computer configured with a CPU 40, a memory 41, a display 42, a user I/F device (a keyboard 43, a mouse 44 and the like), a secondary storage 46 (a hard disk, a flash memory and the like), a network I/F 62 (a LAN card for sending/receiving data with another computer via the network 5) and other related components. Further, the computer is coupled with a security token 45 such as an IC card for verifying the identity of the user. Various programs are stored in the memory 41. A communication control program 50 realizes the communication with another computer, which is carried out via a network I/F 62. A computer unit control program 47 realizes the interaction with the access control server 3. An authentication control program 48 realizes the generation of information indicating the identity of the user by the security token 45. A terminal service control program 49 realizes the transmission of the control information that is input from the user I/F device to the computer unit 2, and the display of the desktop window information that is sent from the computer unit 2 to a display 42.

These programs are initially stored in the secondary storage 46, transferred to the memory 41 according to the necessity, and then executed by the CPU 40 to embody the processing methods as the processes described below, thereby to realize the above processings.

Further, the programs may be previously stored in the secondary storage 46, or may be introduced from the other device via a removable storage medium or communication medium that the computer can use. The communication medium is referred to as the network 5, or a carrier or digital signal that propagates the network 5.

The access control server 3 determines which terminal and which computer unit are permitted to be relayed (in other words, it determines the formation of a “network link”), and issues a setting command to the hub 4.

Herein, the “network link” will be described. Each of the computer units and each of the terminals are physically coupled via the network. The “network link” in the embodiment is a physical communication channel formed on the network, between a specific terminal and a specific computer unit. The use of the formed communication channel allows the application program of the two sides to send and receive application data via the network. Taking an example of the OSI (Open Systems Interconnection) reference model, the communication channel of the embodiment is formed on the lower layer (the transport layer such as TCP, or the network layer such as IP) that provides the application layer with the communication function.

When the communication channel (namely, the “network link”) in the embodiment is not formed on the lower layer, the communication at the application layer, such as the terminal service, cannot be carried out as well. In other words, on the “network link”, the packet between the terminal to which the user is authenticated and the computer unit that the access control server specifies is transmitted, but the other packets are not transmitted.

Further, the network link of the embodiment is a dynamic communication channel that is formed only while the user is using the communication service. Thus, in the case where all users are using the communication service, a number of network links corresponding to the number of the users are formed.

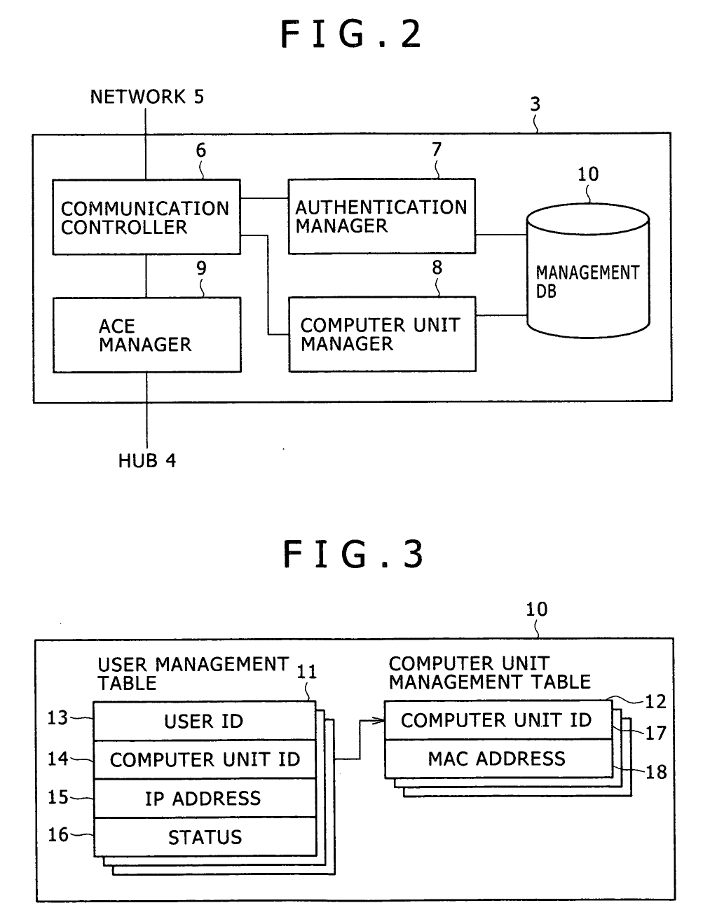

FIG. 2 is a view showing an example of the logical configuration of the access control server 3 in the embodiment.

A communication controller 6 carries out the communication processing with the terminal 1 via the network 5. An authentication manager 7 implements the user authentication by verifying the identity of the user. A computer unit manager 8 carries out the boot and shutdown of the computer unit 2. An ACE manager (link manager) 9 issues the addition or deletion of an ACE (Access Control Entry) pertaining to the relay permission to the hub 4, and causes it to form a network link. A management database (DB) 10 stores the management information on each of the users and each of the computer units 2, and associates a specific user with a specific computer unit.

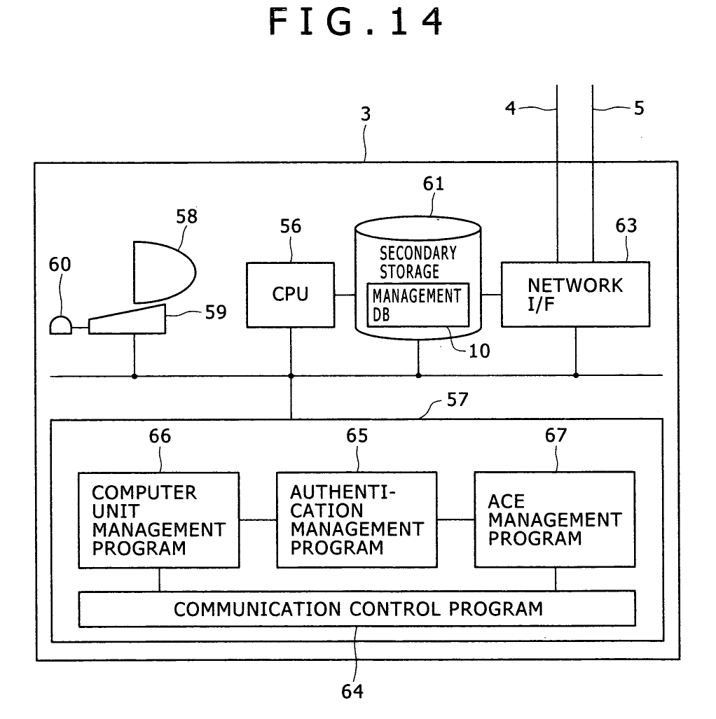

FIG. 14 is a view showing an example of the internal configuration of the access control server 3 in the embodiment.

The access control server 3 is a computer configured with a CPU 56, a memory 57, a display 58, a user I/F device (a keyboard 59, a mouse 60 and the like), a secondary storage 61 (a hard disk and the like), a network I/F 63 (which sends and receives data with the other computer or the hub 4 via the network). Various programs are stored in the memory 57. A communication control program 64 communicates with the other computer or the hub 4 via the network I/F 63. An authentication management program 65 corresponds to the authentication manager 7 of FIG. 2, a computer unit management program 66 corresponds to the computer unit manager 8, and an ACE management program 67 corresponds to the ACE manager 9. These programs are initially stored in the secondary storage 61, and transferred to the memory 57 according to the necessity, and then executed by the CPU 56. The management DB 10 is also stored in the secondary storage 61.

FIG. 3 is a view showing an example of the contents of information that the management DB 10 stores. The information on the users is stored in a user management table 11, and the information on the computer units 2 is stored in a computer unit management table 12.

The user management table 11 has the number of arrays (user entries) corresponding to the number of the users using the computer unit 2. Information stored in each user entry includes a user ID 13 for uniquely identifying the user, an ID 14 of the specific computer unit 2 that the user uses, an IP address 15 thereof, and a status (operation status, coupled/dormant/shutdown) 16 thereof. The status 16 is initialized at “shutdown”, while the values of the other management information are set under the privilege of the system administrator.

The computer unit management table 12 has the number of arrays (computer unit entries) corresponding to the number of computer units 2 to be used. Information stored in each computer unit entry includes a computer unit ID 17 for uniquely identifying the computer unit and an MAC address 18 used for activating the computer unit. The values of the management information are set under the privilege of the system administrator. Incidentally, the array of each piece of the information is not necessarily limited to this. For example, the IP address 15 is the information registered in the OS and is included in the user management table 11, but the IP address 15 may be included in the computer unit management table 12, seeing as the information pertaining to the computer unit 2.

The correspondence between the specific user and the specific computer unit, in other words, the correspondence between each of the user entries and each of the computer unit entries is established by sharing the information on the computer unit ID 14 and on the computer unit ID 17 stored in the entries respectively.

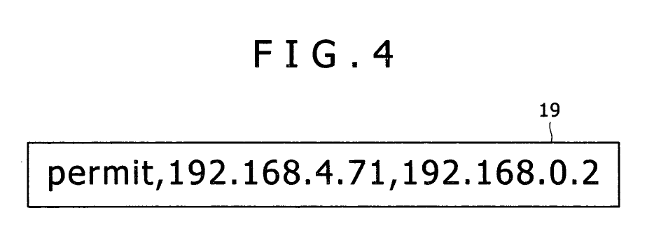

FIG. 4 is a view showing an example of the relay permit/deny information (ACE) that the access control server 3 sets to the hub 4. The ACE is made up of the three parts each separated by a comma “,”. The first part represents the permission or denial of the relay, in which “permit” represents the relay permission and the “deny” represents the relay denial. The second and third parts are to specify the packet of the access control target, in which the second part is the source address (IP address of the sender) and the third part is the destination address (IP address of the receiver). The ACE 19 shown in FIG. 4 is to permit the relay of the packet from the IP address “192.168.4.71” to the IP address “192.168.0.2”.

Plural ACEs can be set to the hub 4. The list of these ACEs is called ACL (Access Control List). In the general hub 4, it is possible to specify the search order when an ACE is added to the ACL. The specification method of the search order includes, for example, a method for inserting as the m-th ACE from the top or inserting as the n-th ACE from the end, and a method for appending a search order number to the ACE to be added. Upon reception of the packet, the hub 4 reads the ACEs in the ACL sequentially according to the search order, and compares to the source address and destination address to be described in the packet. Then, when finding the ACE that is identical to these addresses, the hub 4 refers to the first part of the ACE, and relays or blocks the packet according to its instruction (permit/deny). When the hub 4 cannot find the ACE that is identical to the addresses in the ACL, a default ACE is applied to the packet. The default ACE has only the first part (permit/deny) described therein. In the embodiment, the system administrator sets “deny” in the first part of the default ACE prior to operating the system to make it possible to block the communication between the addresses without being set.

Incidentally, as described below, the access control server 3 of the embodiment sends the packet called a “magic packet” for requesting for boot to the computer unit. A way to send this packet via the hub 4 is to previously set the ACE in which the first part is “permit”, the second part is the IP address of the access control server 3, and the third part is “null” respectively, to the hub 4. When the ACE is “null” for the second or third part, the hub 4 interprets this as being unspecified. In the case of the above-described ACE, the packets that the access control server 3 has sent are all relayed regardless of the destination computer units. Further, in the case where the packet that the computer unit 2 sends to the access control server 3 is present, the ACE having the first part as “permit”, the second part as “null”, and the third part as the IP address of the access control server 3 may be previously added to the hub 4.

Next, the processing flow of the access control service of the embodiment will be described.

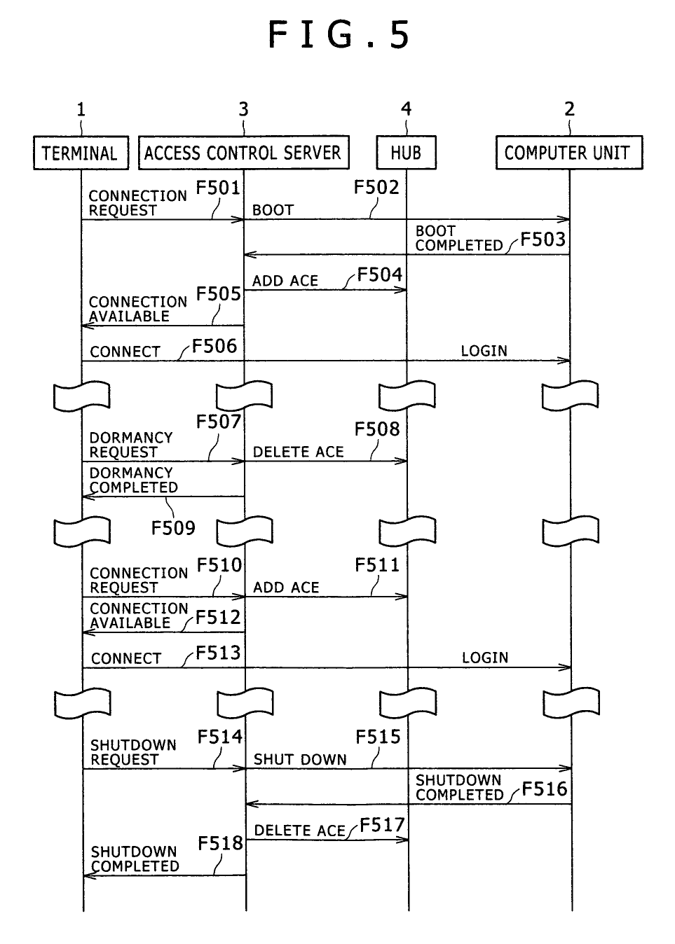

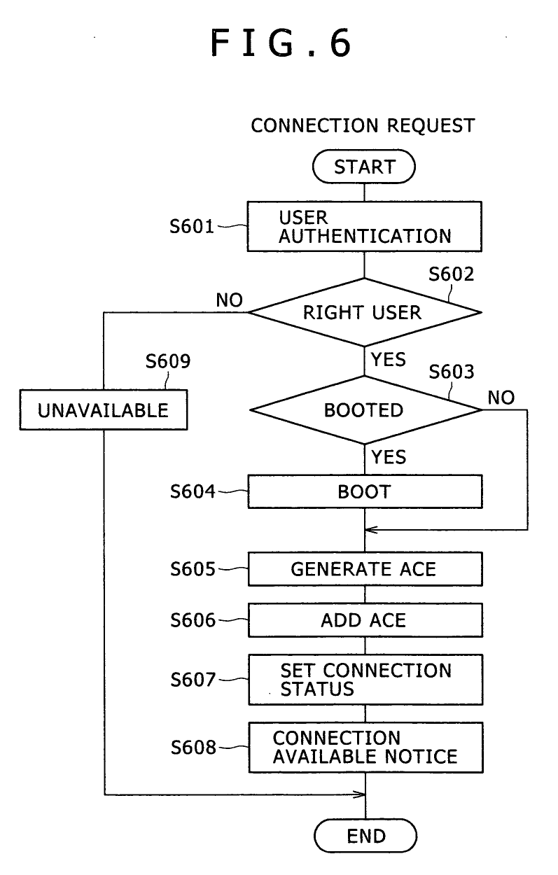

FIG. 5 is a view showing a series of communication sequences among the devices. FIGS. 6, 7, 8 are views showing the flowcharts of the connection processing, dormancy processing, and shutdown processing respectively. Incidentally, the “connected/dormant” referred to herein represents the communication available/unavailable status between the terminal and the computer unit.

First, the description will be made using FIGS. 5 and 6 on the processing that the user operates the terminal 1 to connect to the computer unit 2.

The user operates the computer unit control program 47 of the terminal 1 and sends a connection request (F501) to the access control server 3. The communication controller 6 of the access control server 3 receives the connection request (F501), and asks the authentication manager 7 for the user authentication.

In this embodiment, the TLS (Transport Layer Security) protocol standardized by the IETF (Internet Engineering Task Force), a standardization organization in the Internet, is used as the user authentication method. TLS is the well known technology as SSL (Secure Sockets Layer), which is a protocol for encrypting communication data, in addition to verifying the identity of the sender using the public key cryptography that encrypts or decrypts data by a key pair of a public key and a private key, and the digital certificate that certifies validity of the public key. Depending on the subject to be authenticated, there are provided a server authentication for verifying the identity of the server and a client authentication for verifying the identity of the client. When using the client authentication, each user has his own public key and private key, as well as a digital certificate. These may be stored in the secondary storage 46 of the terminal 1, or may be stored in the security token 45 that can safely store the keys, such as an IC card.

The authentication manager 7 verifies the identity of the user to operate the terminal 1 using the above-described TLS client authentication (S601). As a result of the authentication, when having been able to verify the right user, the authentication manager 7 returns the subject name included in the digital certificate of the user to the communication controller 6. The communication controller 6 passes the subject name to the computer unit manager 8 and asks for the boot of the computer unit 2 (S602).

Upon receiving the request, the computer unit manager 8 searches the user management table 11 within the management DB 10 and finds the user entry in which the same value as the passed subject name is registered as the user ID 13. When finding the entry, the computer unit manager 8 refers to the computer unit ID 14 of the specific computer unit 2 that the user uses and to the status 16 thereof, and confirms whether or not the computer unit 2 is booted (S603). When the value of the status 16 is “shutdown (not booted)”, the computer unit manager boots this computer unit 2.

In this embodiment, a technology called “magic packet” is used for activating the computer unit. The magic packet is a packet for remotely booting the computer coupled via the network, and specifies the computer to be booted by the MAC address that is unique to the LAN card.

The computer unit manager 8 retrieves the value of the computer unit ID 14, and finds the computer unit entry in which the same value is registered in the computer unit ID 17 from the computer unit management table 12. Then, the computer unit manager 8 retrieves the value registered in the MAC address 18 of the found entry, builds a magic packet (F502) including the retrieved value, and sends the magic packet to the computer unit 2 via the network 5 (S604). Upon completion of the boot, the computer unit 2 returns an boot complete notice (F503). The computer unit manager 8 confirms that the boot has been completed, and then retrieves the value registered in the IP address 15 within the user entry to notify the communication controller 6.

Next, the communication controller 6 extracts the source address from the packet of the received connection request (F501), passes the source address to the ACE manager 9, together with the IP address 15 of the computer unit 2 that is notified from the computer unit manager 8, and then asks the ACE manager 9 for additional setting of the ACE.

Upon receiving the request from the communication controller 6, the ACE manager 9 generates the ACE shown in FIG. 4 (S605). More specifically, the configuration of the ACE is that the first part is “permit”, the second part is the passed source address, and the third part is the passed IP address. Next, the ACE manager 9 asks the hub 4 via the administration port for a request to additionally set (F504) the generated ACE (S606). Thus, a network link is formed between the terminal 1 having requested the connection and the specific computer unit 2 the user uses. Subsequently, the ACE manager 9 returns the control to the communication controller 6.

The communication controller 6 asks the computer unit manager 8 to change the value of the status 16 within the user entry into “connected” (S607). Then, the communication controller 6, as the response to the connection request (F501), returns the connection available notice (F505) indicating that the connection has been made to the terminal 1, together with the IP address 15 of the computer unit 2 notified from the computer unit manager 8 (S608).

Upon reception of the connection available notice (F505), the computer unit control program 47 of the terminal 1 transmits the notified IP address to the terminal service control program 49. The terminal service control program 49 sends a terminal service connection request (F506) to the computer unit 2 using the IP address. Then, the user inputs the user ID and the password in the login window, and then carries out the PC Job with the provision of the terminal service.

In the above-described authentication process (S602), when the authentication manager 7 failed to verify the identity of the user to operate the terminal 1, the communication controller 6 returns the unavailable notice to the terminal 1 (S609), and does not carry out the boot or setting of the network link to any of the computer units 2.

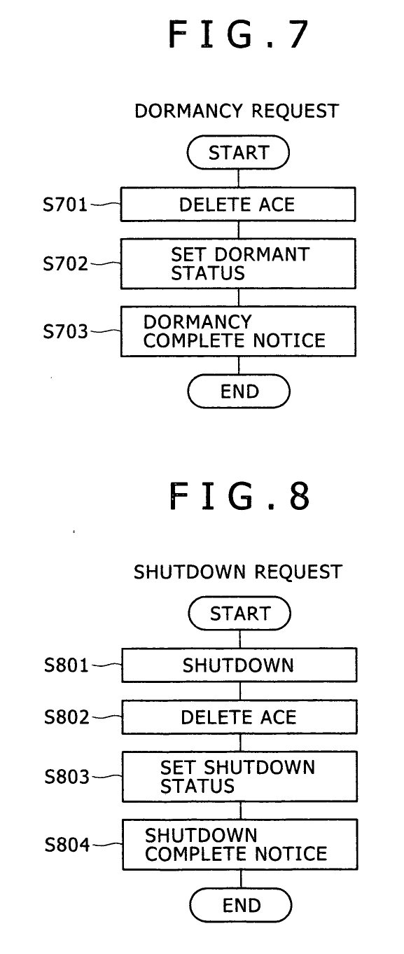

Next, a description will be made using FIGS. 5 and 7 on the case of carrying out the dormancy processing when the user is temporarily away from the terminal 1. This will be effective to prevent another user from operating the terminal to attempt an illegal access during the absence of the right user.

The user operates the computer unit control program 47 of the terminal 1 when away from the terminal 1, and sends a dormancy request (F507) to the access control server 3. The communication controller 6 of the access control server 3 receives the dormancy request (F507), and asks the ACE manager 9 to delete the ACE.

Upon reception of the request from the communication controller 6, the ACE manager 9 asks the hub 4 via the administration port for a request to delete the ACE (F508) additionally set in the above-described setting process (S606 of FIG. 6) (S701). Thus, the network link having been set between the currently coupled terminal 1 and the specific computer unit 2 that the user uses is released, and thereby the communication between the both sides is blocked. However, the computer unit 2 keeps the boot status. Subsequently, the ACE manager 9 returns the control to the communication controller 6.

Next, the communication controller 6 asks the computer unit manager 8 to change the value of the status 16 within the user entry into “dormant” (S702). Then, the computer unit manager 8, as the response to the dormancy request (F507), retunes an dormancy complete notice (F509) indicating the dormancy processing has been normally completed to the terminal 1 (S703).

Subsequently, the user returns at the terminal 1 and restarts the PC Job. The processing in the restart is the same as in the connection request described above with reference to FIG. 6. The user operates the computer unit control program 47 of the terminal 1, and sends a connection request (A510) to the access control server 3 to carry out again the user authentication and the setting of the ACE. However, as the computer unit 2 to be coupled is already in the boot status of “dormant”, the process of activating the computer unit 2 (S604) is skipped. The ACE manager 9 sends an addition request of the generated ACE (F511) to the hub 4 (S606), so that the network link having been interrupted between the terminal 1 and the specific computer unit 2 is formed again.

Upon reception of a connection available notice (F512), the computer unit control program 47 of the terminal 1 starts the terminal service control program 49, and sends a terminal service connection request (F513) to the computer unit 2. Then, the user carries out the login operation (inputs the user ID and the password) to restart the PC job.

Next, the description will be made using FIGS. 5 and 8 on the shutdown processing when the user terminates the PC job, such as before going home.

The user, when terminating the PC job, operates the computer unit control program 47 of the terminal 1 and sends a shutdown request (F514) to the access control server 3. The communication controller 6 of the access control server 3 receives the shutdown request (F514), and asks the computer unit manager 8 to shut down the computer unit 2.

Upon reception of the shutdown request, the computer unit manager 8 sends a shutdown request (F515) to the computer unit 2 via the network 5, and waits for a shutdown complete notice (F516). The computer unit manager 8 confirms the shutdown has been completed, and then returns the control to the communication controller 6.

The communication controller 6 asks the ACE manager 9 to delete the ACE. The ACE manager 9 asked by the communication controller 6 issues a request to delete the currently set ACE (F517) to the hub 4 via the administration port (S802). Thus, the network link having been set between the currently coupled terminal 1 and the specific computer unit 2 is released, and thereby the communication between the both sides is blocked. Subsequently, the ACE manager 9 returns the control to the communication controller 6.

Further, the communication controller 6 asks the computer unit manager 8 to change the value of the status 16 within the user entry to “shutdown” (S803). Then, as the response to the shutdown request (F514), the computer unit management 8 returns, to the terminal 1, a shutdown complete notice (F518) indicting that the shutdown processing has been normally completed (S804).

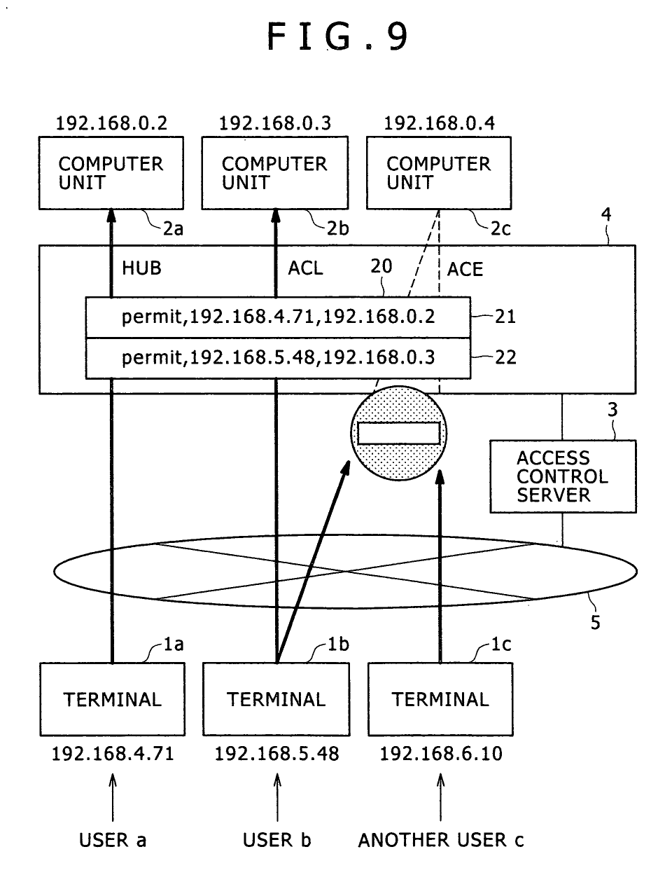

Next, the description will be made using FIG. 9 on the access control action according to the embodiment and the advantage thereof, in other words, on the illegal access prevention function.

The network 5 is coupled with the three terminals 1a, 1b, 1c and the three computer units 2a, 2b, 2c. The IP addresses of the terminals are set to “192.168.4.71”, “192.168.5.48”, and “192.168.6.10” respectively. The IP addresses of the computer units are set to “192.168.0.2”, “192.168.0.3”, and “192.168.0.4” respectively. It is also assumed that two users a, b operate the terminals 1a, 1b respectively, and they can use the specific computer units 2a, 2b respectively.

The user a who operates the terminal 1a sends the connection request to the access control server 3. The access control server 3 confirms the identity of the user a, and then asks the hub 4 to add an ACE 21 to an ACL 20. Thus, a network link is formed between the terminal 1a and the computer unit 2a to allow the packet to be sent and received therebetween. As a result, the user a who operates the terminal 1a becomes able to receive the terminal service that the computer unit 2a provides.

Similarly, in the case of the terminal 1b, the access control server 3 asks the hub 4 to add an ACE 22, and then a network link is formed between the terminal 1b and the computer unit 2b. Thereby, the user b who operates the terminal 1b becomes able to receive the terminal service that the computer unit 2b provides.

Herein, the terminal 1c in which the user is not authenticated by the access control server 3 is not identical to any of the ACEs within the ACL 20. In other words, there is no network link formed between the terminal 1c and any of the computer units, so that the other user c cannot access any of the computer units by operating the terminal 1c. Further, even with the terminal to which the user is authenticated by the access control server 3, the user cannot access the computer unit other than the specific one. For example, there is no network link formed between the terminal 1b and the computer unit 2c, so that it is impossible to access from the terminal 1b to the computer unit 2c. Further, it is impossible to access from the computer unit to the other computer unit. For example, the user b makes a terminal service connection from the terminal 1b to the computer unit 2b and then attempts a terminal service connection from the computer unit 2b to the computer unit 2c, but the user cannot access the computer unit 2c.

As described above, the access control service and access control server of the embodiment does not set the network link that enables communication, except for between the terminal to which the user is authenticated and the specific computer unit that the user uses. The system administrator and the like in charge previously define which user can use which computer, and stores such information in the access control server. Thus, it is impossible to access to the computer unit of the right user not only from the terminal to which the user is not authenticated, but also from the terminal in which another user is authenticated. In other words, another user cannot attempt to log in by attempting the terminal service connection to the computer unit because the network is blocked by the hub and the login window is not even displayed. This makes it possible to provide a safety access control service that can eliminate the password crackings such as the brute force attack, dictionary attack, and the harassment action done by abusing the account lockout function and that further protects the computer unit from the illegal accesses such as the port scan attack and DoS attack.

Incidentally, the access control server of the embodiment sets the network link in the case where the user is operating the terminal to which the user is authenticated (the user is carrying out the PC job). The access control server releases the network link in the operation dormancy and the operation shutdown, so that the user's own computer unit does not suffer the password crackings from the others even while the user is absent or going home. Further, the access control server of the embodiment first authenticates the user having sent the connection request, and when succeeding in authenticating the user, the access control server recognizes the terminal the authenticated user currently operates, and sets the network link relative to this terminal. Thus, the terminal that the user operates or the network environment to which the terminal is coupled is not fixed, so that the user can receive the terminal service without limitation of the terminal and environment, for example, such as in the case where the user uses the PC or the network environment away from home and at home.

With the known technologies, the system administrator needs to manually set all IP addresses of the network to which the terminal is coupled to the ACL of the hub, so that the work load is huge in a large scale network environment. Further, although the IP address of the terminal is registered in the ACL of the hub, the person who operates the terminal is not always the right user. In addition, another user can illegally access the computer by spoofing the terminal IP address and the like, while the right user is not using the computer unit.

With the embodiment, the access control server detects the terminal IP address and automatically adds the IP address to the ACL of the hub, so that the maintenance work of the system is facilitated. Further, the network link of the embodiment is not provided to the user whose identity has not been authenticated. The network link may be exclusively provided while the user is using the computer unit. With these features, it is possible to protect the computer unit from the illegal access by another user.

The above-described embodiment is an example, and different variants described below will be possible.

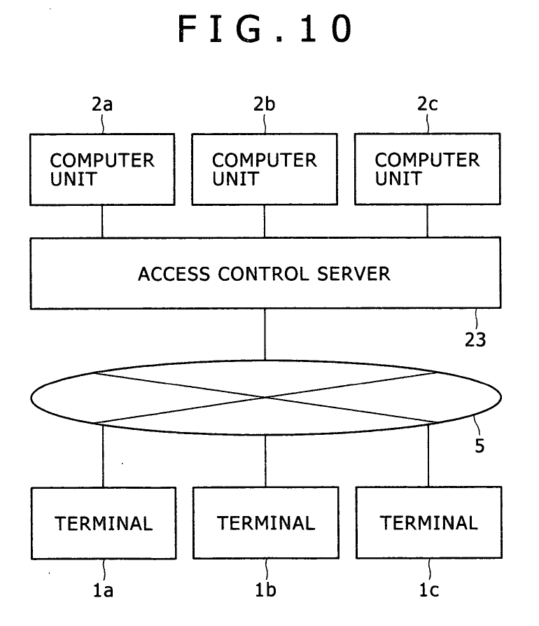

The access control service of the embodiment is configured such that the access control server 3 and the hub 4 are separated from each other. Because of this configuration, a general purpose hub can be used therein. On the other hand, as shown in FIG. 10, the access control service can also be configured such that the access control server is integrated with the hub as an access control server 23.

The access control server of the embodiment asks for the addition and deletion of the ACE via the administration port of the hub, but the server may ask for the addition and deletion of the ACE via the network 5 depending on the specification of the hub, such as not including the administration port.

The access control server of the embodiment identifies the terminal and the computer unit using the source and destination addresses of the packet, but the access control server may identify these devices using other identifier.

The embodiment has exemplified the case where the network link is realized by the function of controlling relay permit/deny of the hub, but the network link can be realized using another method. For example, when a function capable of limiting to the communication between the specific computers, such as VLAN (Virtual LAN) is incorporated into the hub, the network link may be realized using this function. Further, when a firewall function is incorporated into the computer unit, a certain amount of advantage can be achieved without using the hub. A way to use the firewall function of the computer unit is to replace the hub to which the access control server carries out the addition and deletion processings of the ACE with the firewall function of the computer unit, and to ask the firewall to accept the packet from the specified source address.

Incidentally, the description has been made in the embodiment on the network link that is formed from the ACE having the terminal address as the source address and the computer unit address as the destination address. Because of this feature, the packet other than from the terminal to which the user is authenticated to the specific computer unit is not relayed. However, the packet may actually be sent in the reverse direction, in other words, from the specific computer unit to the terminal to which the user is authenticated. A way to cope with this case is to generate and add the ACE shown in FIG. 4, and at the same time, to generate and add the ACE of the reverse direction in S605 and S606 of FIG. 6. More specifically, the ACE is that the first part is “permit”, the source address of the second part is the computer unit address, and the destination address of the third part is the terminal address. By adding the two ACEs, it is possible to provide the network link through which the terminal to which the user is authenticated and the specific computer unit can be communicated in the both directions.

In this embodiment, the network link is provided by identifying the terminal using the source address of the packet. However, there might be a case where all of the source addresses of the packets that the hub receives are the same regardless of the terminal, such as when a proxy or a gateway is present between the terminal and the hub. In such a case, the terminal is identified by another method. For example, the terminal can be identified by the combination of the source address and the communication port number. In the general hub 4, not only the address but also the combination with the communication port can be specified as the second or third part of the ACE. In this case, the source address and the communication port number are described in the second part of the ACE shown in FIG. 4.

The access control server of the embodiment provides the network link between the specific terminal and the specific computer unit with the source address and destination address of the packet as shown in FIG. 4, in which every packet can be sent and received between the specific terminal and the specific computer unit. However, considering security and other issues, there might be a need to restrict the packet between the terminal and the computer unit to a specific protocol.

A way to satisfy such a need is to set the value in which the destination address and the port number of the communication protocol permitting the use are combined, to the third part of the ACE shown in FIG. 4. For example, a way to restrict to the terminal service is to set the port number of the terminal service protocol (for example, 3389). In this case, the network link can be the network link dedicated to the terminal service. Further, a way to provide a two-way network link is to generate and add the ACE of the reverse direction as well.

More specifically, the ACE is that the first part is “permit”, the second part is the value in which the computer unit address and the port number of the terminal service protocol are combined, and the third part is the terminal address. Alternatively, the ACE may be such that the first part is “permit”, the second part is the computer unit address, and the third part is the value in which the terminal address and the port number of the terminal service control program are combined. In this case, it is assumed that the access control server detects the port number of the terminal service control program of the terminal.

The access control server of the embodiment provides the network link between the specific terminal and the specific computer unit, so that no terminal other than the specific terminal can access the specific computer unit via the network. However, there might be a case where the user wants to accept another communication protocol, such as a Web server, in the computer unit.

In addition, the application programs for communicating with other computers are indispensable for the current PC Jobs, such as Websites and e-malls. The embodiment has exemplified the application to the terminal service, in which each computer unit needs to communicate with the other computers. When the other computers are coupled on the network 5, the network must be designed not to block the communication of the application programs.

A way to cope with the above two cases is to add the ACE having the first part as “deny”, the second part as “null”, and the third part as the combination of the address of each computer unit (or “null”) and the communication port number to which the terminal service is provided, as the search order later than the ACE that the access control server adds. In addition to this, the ACE having the first part as “permit” is registered as the default ACE. The system administrator or other parson in charge previously sets these ACEs to the hub 4. Thus, it is possible to accept the communication other than the terminal service between the computer unit and the other computer, while ensuring the illegal access protection function that no terminal other than the specific terminal can connect to the terminal service, in other words, can attempt to log in.

However, with the setting as described above, the magic packet to boot the computer unit is also passed though, and when the MAC address of the computer unit is found, the computer unit might be illegally booted from any of the terminals. Thereby, a further action is required.

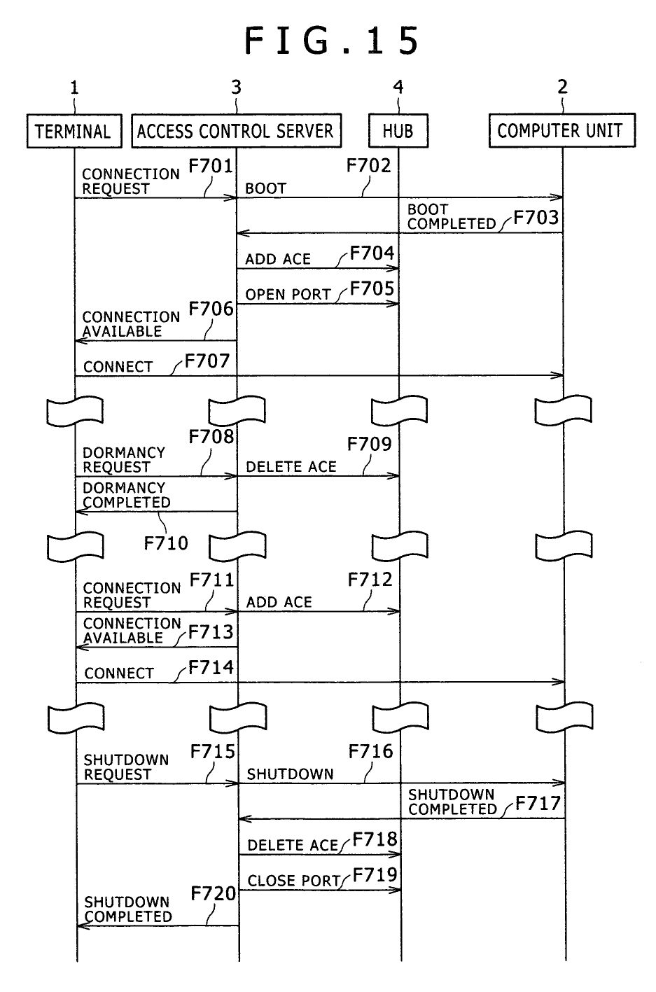

FIG. 15 is an example where the above-described series of communication sequences of FIG. 5 is varied in order to cope with the above case. Herein, it is designed to control not only the packet filtering by the ACE, but also the opening and closing of the hub port with the computer unit coupled thereto.

Upon reception of a connection request (F701) from the terminal 1, the access control server 3 confirms the identity of the user, and asks the hub 4 to add the ACE (F704) after activating the computer unit 2 (F702), as well as to open the port with the computer unit 2 coupled thereto (F705). When receiving shutdown request (F715) from the terminal 1, the access control server 3 asks the hub 4 to delete the added ACE (F718) after shutting down the computer unit 2 (F716), as well as to close the port having been opened in F705 (F719). The access control server 3 indicates the opening and closing of the port to the hub 4, for example, with the number of the port. Thus, each computer unit management table is provided with an area for storing the number of the port to which the computer unit is coupled. This makes it possible to prevent the illegal boot of the computer unit 2.

Further, the control may be changed so that the port is closed when the computer unit 2 does not need to communicate with the other devices, while the user is interrupting the PC Job. For example, the access control server 3 receives an dormancy request (F708) from the terminal 1, and asks the hub 4 to delete the ACE having been added in F704 (F709) and then to close the port having been opened in F705. When receiving a connection request (F711) from the terminal 1, the access control server 3 asks the hub 4 to add the ACE (F712) and then to open the closed port. The same advantage can be obtained by replacing “Delete ACE” of F709 with “Close Port”, and “Add ACE” of F712 with “Open Port”, respectively.

The embodiment has been described by taking an example of the P2P-type terminal service, but the embodiment can be also applied to the SBC-type terminal service. The user who is not authenticated cannot even attempt to connect to the SBC-type terminal service. Further, the SBC-type terminal service is the service in which plural users shares one computer unit. As the users who can share one computer unit, it is appropriate to assign a group of several dozen users. Thus, the user not belonging to a certain group cannot access a specific computer unit. In addition, it is possible to protect the privacy among users by identifying the communication data for each user. The embodiment can be further developed to the service mode that is among plural users and a specific plurality of computer units. A way to realize this mode is to add information for specifying the computer units to be accessed.

Incidentally, in the known terminal service, the terminal and the remote computer send and receive data via the network, so that when they become unable to send and receive the data due to a network failure or other disruption, the communication session of the terminal service is disconnected. The user can restart the PC job by reconnecting the terminal service to the remote computer the user has been used, after the network is restored. However, in the case where the terminal service becomes unavailable due to the network failure or other disruption and when the user is away without carrying out the dormancy operation of the embodiment, the computer unit might suffer the password cracking by another user using the terminal that the right user has used, after the network is restored.

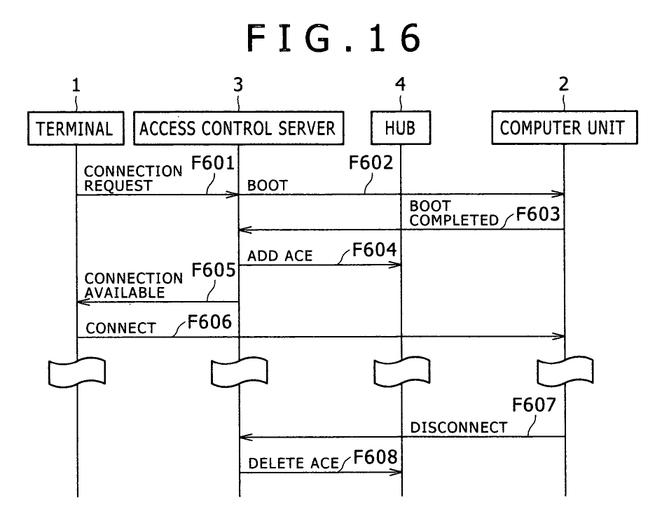

FIG. 16 is an example where the above-described series of communication sequences of FIG. 5 is varied in order to cope with the above case. Herein, the formed network link is released, when the communication between the terminal and the computer unit becomes impossible.

An agent for monitoring the communication status with the terminal 1 is running on each of the computer units 2. The agent detects that the communication with the terminal 1 is disconnected, and notifies the access control server 3 about this situation (F607). The access control server 3 receives the disconnect notice, similarly to the procedure shown in FIG. 7, asks the hub 4 to delete the ACE having been additionally set in F604 (F608), and then releases the network link having been set between the terminal 1 and the computer unit 2. This makes it possible to prevent the illegal access to the computer unit after the network is restored.

Further, in the general terminal service client (the terminal service control program 49 of FIG. 13), the user can disconnect the terminal service communication session with the remote PC. It is assumed in the embodiment that the user, when away from the terminal 1, operates the computer unit control program 47 of the terminal 1 to send the dormancy request to the access control server 3. However, when the user disconnects the terminal service communication session before the dormancy request, the network link remains formed. Although the other terminal cannot access the computer unit, it is safer for the user to release the network when not using the terminal service, in preparation against a potential illegal access. A way to cope with this is to add a processing that the computer unit control program 47 of the terminal 1 monitors the terminal service communication session with the remote PC and automatically sends the dormancy request to the access control server 3 when detecting disconnection.

In the embodiment, the illegal access to the computer unit is blocked by the hub. With a configuration that notifies the system administrator about the information pertaining to the illegal access blocked by the hub (the IP address of the terminal, packet, protocol and the like), the system administrator can immediately take the action against the illegal access, thereby an even safer system can be established. The notice of illegal access to the system administrator may be made using a function of the hub. When the hub does not have the function, there may be added a process that the access control server extracts the information from the log of the hub and the like to notify the system administrator about it.

The access control server of the embodiment uses TLS as the user authentication method, but the server may use another method as long as can verify the identity. For example, the biometrics authentication using the inherent characteristics of human beings, such as fingerprint, iris, and finger vein is also useful.

The computer unit in the embodiment is a general-purpose PC or other related machines, having a CPU, a hard disk, a LAN card and other components incorporated into a package thereof. However, the role of the computer unit in the embodiment is to provide the terminal service, so that the computer unit does not necessarily need the package and may only have a board on which the CPU, hard disk, LAN card and other components are implemented. Such a board is generally called as a blade computer. The blade computer has become introduced to various types of systems, and it can be applied as the computer unit of the embodiment as well.

The embodiment has exemplified the case where the boot of the computer unit is realized by the magic packet, but it can be realized using another method. For example, when the computer unit supports IPMI (Intelligent Platform Management Interface), the boot of the computer unit can be realized using this.

Incidentally, upon reception of the connection request from the terminal, the access control server of the embodiment confirms the operation status of the computer unit, boots the computer unit when it is not booted, and after completion of the boot, notifies the terminal about the completion of the preparation for connection to the terminal service. The terminal receives this notice and starts the terminal service connection to the computer unit. However, as it takes tens of seconds to a few minutes to boot the general computer unit, the access control server preferably notifies the user that the computer unit is being booted. A way to cope with this is to add a processing for notifying the terminal 1 that the computer unit is being booted before the boot of the computer unit (S604 of FIG. 6). The terminal 1 receives the notice and displays on a display 42 a message saying, such as, “PC is being booted. Wait for a while.”

In this embodiment, the system administrator previously registers the IP address of each computer unit in the management DB, which assumes an operation mode of assigning the fixed IP address to each computer unit. On the other hand, there might be an operation mode of dynamically assigning the IP address to each computer unit. In this operation mode, a DHCP (Dynamic Host Configuration Protocol) server is generally used. A way to apply the embodiment to the dynamic IP address is to incorporate a program for notifying the IP address into each computer unit. The program is executed each time the computer unit is booted to detect the IP address assigned by the DHCP server, and then notifies the access control server. Upon reception of this notice, the access control server stores the value in the IP address area of the management DB and refers to in the subsequent processings.

Incidentally, the description has been made in the embodiment on the configuration of one access control server. However, in order to build a highly reliable system such as a non-stop operation, the system is redundant with two or more access control servers. It is configured to be able to continue the service by switching to another server when the currently operating server is disabled due to a device failure and the like. It is also configured to run plural access control servers and operates the servers in parallel, when the processing capacity is insufficient with one access control server, such as a large scale system having a large number of users. In this case, the loads of the access control servers can be equalized by sending the request from each terminal to the access control server with the least load, or by providing a load balancer between the access control server and the network.

### Embodiment 2

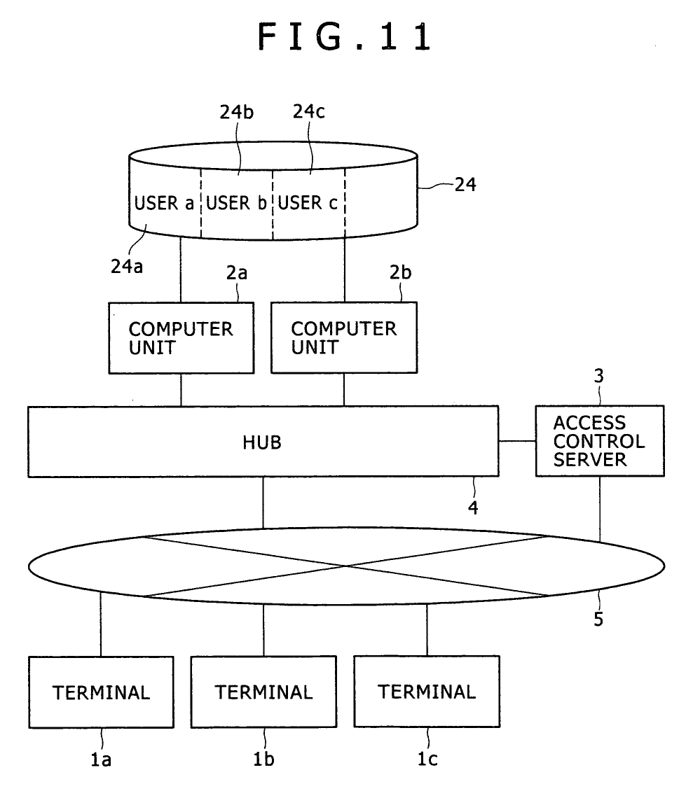

FIG. 11 is a configuration view showing a second embodiment of a computer system for carrying out the access control service according to the present invention. The embodiment has a configuration in which the computer units share a high-capacity hard disk. This embodiment differs from the first embodiment in that each user does not exclusively own a specific computer unit, but a dedicated area is provided in the hard disk. The system of the embodiment is designed to share the computer units the users use, allowing effective operation with less number of computer units.

One or more (herein, two) computer units 2 (2a, 2b) are coupled to a high-capacity hard disk 24. The hard disk 24 is divided into discrete areas for each of registered users (herein, three users a, b, c), and the data and the software such as the OS each user uses and application programs used for the jobs are stored in each of the areas (24a, 24b, 24c). When the user (for example, the user a) starts using, a user area (24a) on the hard disk 24 is mounted, and the computer unit 2 is booted by the OS stored in the user area. The computer unit 2 to be used therein is dynamically assigned to any of the computer units 2 in the empty status. In the embodiment, the computer units 2 and hard disk 24 are separated from each other, so that there is no need to statically assign the computer unit 2 to the user to use it.

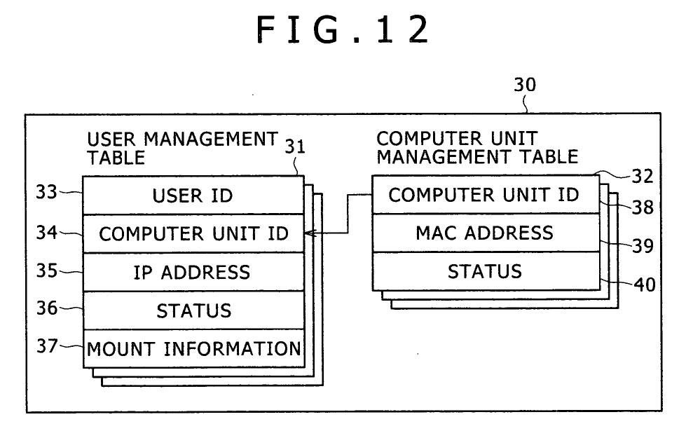

FIG. 12 is a view showing an example of the information of a management DB 30 that the access control server 3 according to the embodiment has. Mount information 37 indicating the user area on the hard disk 24 is added in the user entry of a user management table 31, and status information (operation/empty) 40 of the computer unit 2 is added in the computer unit entry of a computer unit management table 32. As for the mount information 37 in the user entry, the system administrator registers the information in the user registration. The status information 40 in the computer unit entry is initialized to “empty” in the system introduction. As for a computer unit ID 34 in the user entry, the access control server 3 sets the value, so that the system administrator does not need to previously register it. In the embodiment, the service can be carried out with the number of computer units to be used being equal to or less than the number of users. Alternatively, the number of computer units to be used is equal to or less than the number of terminals 1 to be coupled to the network.

The description will be made on the flow of the connection processing of the control service according to the embodiment. Incidentally, the parts common to those of the first embodiment will be described also with reference to the drawings (FIGS. 5, 6). The access control server 3 verifies the right user as a result of the user authentication (S601), and then the computer unit manager 8 makes the mount of the hard disk 24 and the boot the computer unit 2 (S604).

First, the computer unit manager 8 searches the computer unit management table 32, finds the computer unit entry in which “empty” is registered as the status information 40, and changes the status information 40 of the entry to “operation” to define as the computer unit to be used this time. Next, the computer unit manager 8 searches the user management table 31, finds the user entry in which the authenticated user is registered, and retrieves the value of the mount information 37 registered in the entry. Then, the computer unit manager instructs the computer unit 2 to be used therein to mount the hard disk 24 based on the mount information 37. Then, the computer unit manager retrieves the value registered to a MAC address 39, assembles the magic packet (F502), and sends the magic packet to the computer unit 2 to allow it to boot.

Upon reception of the boot complete notice (F503), the computer unit manager 8 registers the value registered to the computer unit ID 38 in the computer unit entry, to the computer unit ID 34 in the user entry, and retrieves the value registered to the IP address 35 and then passes the value to the communication controller 6.

The communication controller 6 extracts the source address of the terminal 1 having requested the connection, from the received packet, and passes the source address to the ACE manager (link manager) 9, together with the IP address 35 of the computer unit 2 to be used that is notified from the computer unit manager 8. The ACE manager 9 generates the ACE (S605), and asks the hub 4 for a request to additionally set the ACE (F504) (S606). The configuration of the ACE is the same as in the above-described first embodiment 1. Thus, the network is formed between the terminal 1 having requested the connection and the computer unit 2. As a result, the user can carry out the PC job, after logging in, with the provision of the terminal service from the computer unit 2 on which the specific user area of the hard disk is mounted. The user carries out the processings of dormancy and shutdown of the PC Job in the same manner as in the embodiment 1.

As described above, in this embodiment, the network link enabling communication is not set, except for between the terminal to which the user is authenticated and the specific computer unit that the user uses. This makes it possible to eliminate the password cracking, thereby a safety access control service can be provided.

Further, in this embodiment, the computer units share a high-capacity hard disk, so that each of the computer units is not necessarily required to have the hard disk. In addition, the computer unit in the “empty” status is dynamically assigned to the user to use, so that the computer resource can be effectively used. In other words, the number of computer units is as many as the number of users to use at the same time. Further, although a failure occurs in part of the computer units, replacement computer units can be immediately assigned, which leads to a reduction in the size of the system and an improvement in the reliability.

As another embodiment of the present invention, a mode in which the above-described first and second embodiments are combined is also possible. In other words, the computer units share the high-capacity hard disk, and each user exclusively owns the specific computer unit and the specific area within the hard disk.

Further, in this embodiment, any of the computer units in the “empty” status is dynamically assigned to the user who has requested the connection. However, for example, a damaged computer unit or a computer unit unable to communicate due to the network failure should be excluded from the target to be assigned, even if the computer unit is in the empty status. The factor of the network failure includes the failure of the hub itself or one of the ports in the hub, and the disconnection or removal of a cable connecting the hub and the computer unit. Further, a certain computer unit may be excluded from the target to be assigned according to the determination of the system administrator. By assigning the computer unit as described above, it is possible to provide the user with the computer unit that user can comfortably use.

### Embodiment 3

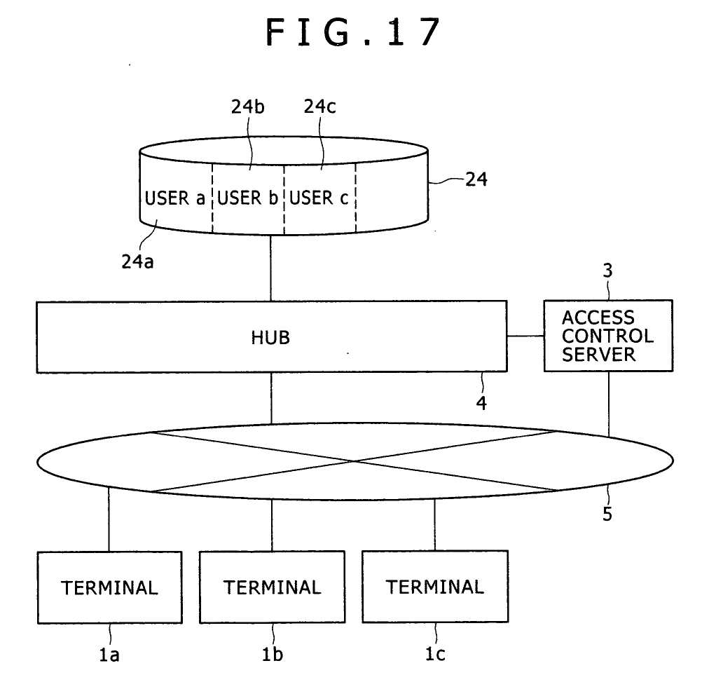

FIG. 17 is a configuration view showing a third embodiment of a computer system for carrying out the access control service according to the present invention. The embodiment has a configuration in which the terminals share a high-capacity hard disk (storage) via a network. Similarly to the second embodiment (FIG. 11), the hard disk is divided into discrete areas for each of the registered users, and the data and the software such as the OS each user uses and the application programs used for the jobs are stored in each of the areas. The configuration in the second embodiment is that the computer units share the hard disk and the terminal is coupled to the computer unit using the terminal service. However, the configuration in this embodiment is that the computer units are eliminated and the terminals share the hard disk. In other words, the system in this embodiment is that the data and the software such as the OS and application programs are stored in the remote hard disk, but the software is executed by the CPU and not using the terminal service. In the configuration of the embodiment, the computer units of the first or second embodiment are not necessary, so that the introduction cost of the system can be reduced. Meanwhile, as the writing and reading of the data to the hard disk are all carried out via the network 5, a high speed network is required with an increased access frequency from each terminal to the hard disk.

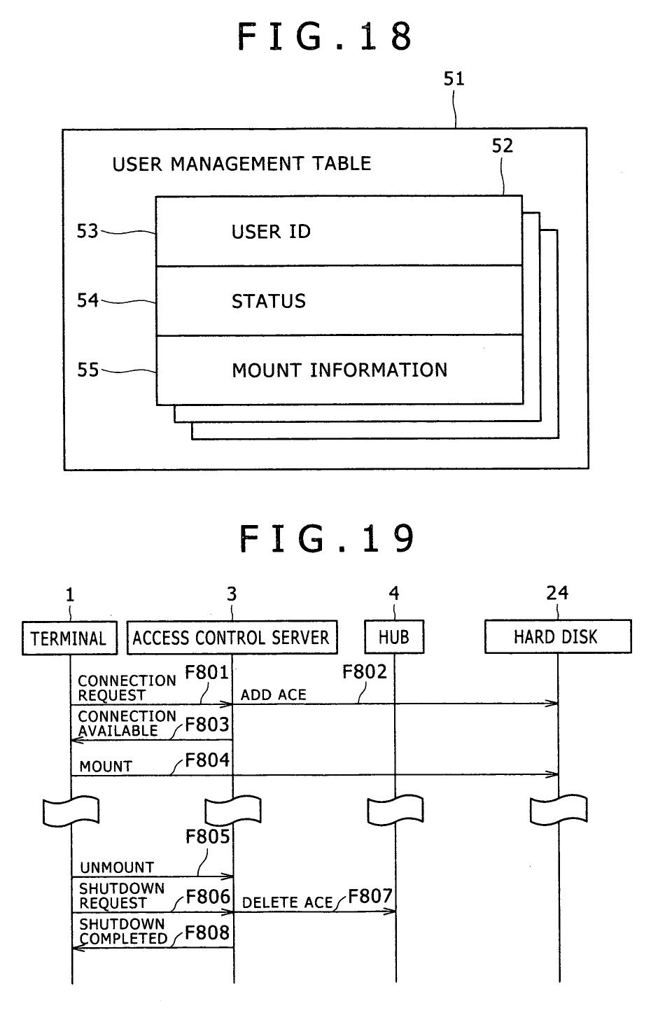

FIG. 18 is a view showing an example of the information of a management DB 51 that the access control server 3 in the embodiment has. The information to be stored in each user entry of a user management table 52 includes a user ID 53 for uniquely identifying the user, a status (operation status, connected/dormant/shutdown) 54 in the user area on the hard disk 24, mount information 55 indicating the user area on the hard disk 24 and other information.

FIG. 19 is a view showing a series of the communication sequences among the devices in the embodiment.

The user operates the terminal 1 and sends a connection request (F801) to the access control server 3. Upon reception of the connection request, the access control server 3 implements the user authentication, and when having been able to verify the identity of the user, then asks the hub 4 to add the ACE (F802). More specifically, the configuration of the ACE is that the first part is “permit”, the second part is the IP address of the terminal, and the third part is the IP address of the hard disk. Incidentally, when the device to be coupled to the hub 4 is the single hard disk 24, the third part may also be “null”. Next, the access control server 3 finds the user entry of the user having issued the connection request, and changes the status 54, as well as retrieves the value of the mount information 55 to notify the terminal 1 (F803). The terminal 1 asks the hard disk 24 to mount (F804) using the mount information indicating the user area notified from the access control server 3. After completion of the mount, the terminal 1 reads and boots the OS stored in the hard disk. Subsequently, the user accesses the user dedicated area on the remote hard disk 24 to carry out the application programs and the processings such as reading/writing the data.

When terminating the PC job, the user first asks the hard disk 24 to unmount (F805), and then sends a shutdown request (F806) to the access control server 3. Upon reception of the shutdown request, the access control server 3 asks the hub 4 to delete the ACE (F807), and after completion of the deletion, notifies the terminal 1 that the shutdown is completed (F808).

As described above, with the access control service and access control server of the embodiment, the network link enabling the communication with the user dedicated area on the shared hard disk is set to the terminal to which the user is authenticated. The access to the hard disk from the terminal to which the user is not authenticated is blocked at the network level, so that the data of each user can be safely protected.

The embodiment has exemplified the case where the terminals share a single hard disk. However, plural hard disks can also be set depending on the number of users, the disk area to be assigned to each user and the other factors. For example, in the case where the number of users is 500 and an area of 20 gigabytes is assigned to each of the users, it is necessary to provide 10 hard disks each having an area of 1 terabyte and to separately use the hard disks depending on the user. A way to cope with this case is to register, to the mount information 55, the information indicating the IP address and user area of the hard disk the user uses, and to form a network link between the terminal to which the user is authenticated and the hard disk that the user uses.

The specification and drawings are, accordingly, to be regarded in an illustrative rather than a restrictive sense. It will, however, be evident that various modifications and changes may be made thereto without departing from the spirit and scope of the invention as set forth in the claims.

We claim:

1. An access control service carrying out communication by connecting one or more computer units with one or more terminals via a network to access from the terminal to the computer unit, the access control service comprising a control server for authenticating a user to operate the terminal and for setting a network link that enables communication between the terminal that the user operates and the specific computer unit in accordance with a result of the authentication.

2. The access control service according to claim 1,
wherein, in the control server, information on each user and information on the specific computer unit that the each user can use are associated with each other and registered.

3. The access control service according to claim 1, further comprising a hub for establishing the network link between the network and each of the computer units,
wherein the hub relays a packet between a specified terminal and a specified computer unit by a control command from the control server.

4. The access control service according to claim 3, wherein the access control server issues, to the hub, the control command in which identifier of the terminal that the user operates and identifier of the computer unit are combined together.

5. The access control service according to claim 3, wherein the control server is integrally configured with the hub.

6. The access control service according to claim 1, wherein the control server releases the established network link, upon reception of a request from the terminal.

7. The access control service according to claim 6, wherein the control server releases the established network link in a case where the user interrupts or terminates the operation of the terminal.

8. The control access service according to claim 1,
wherein the computer units share a storage.

9. An access control service carrying out communication by connecting one or more computer units with one or more terminals via a network to access from the terminal to the computer unit, the access control service comprising:
a shared storage coupled to each of the computer units, having an available storage area assigned to each user; and
a control server for authenticating a user to operate the terminal, mounting the storage area within the storage assigned to the user in accordance with a result of the authentication in any of the computer units, and setting a network link that enables communication between a terminal that the user operates and the mounted computer unit.

10. The access control service according to claim 9, wherein, in the control server, information on each user and information on the storage area within the storage that the each user can use are associated with each other and registered.

11. The access control service according to claim 9, wherein the number of the computer units coupled to the network is equal to or less than the number of the terminals.

12. The access service according to claim 9, wherein the control server mounts the storage area within the storage assigned to the user, to an available computer unit of the computer units.

13. In a computer system in which one or more computer units and one or more terminals are coupled via a network, a control server for controlling communication between the terminal and the computer unit, comprising:
an authentication manager for authenticating a user to operate the terminal; and
a link manager for setting a network link that enables communication between a terminal that the user operates and the specific computer unit in accordance with a result of the authentication.

14. The control server according to claim 13, further comprising a management database in which information on each user and information on the specific computer unit that the each user can use are associated with each other and registered.

15. The control server according to claim 13, wherein the link manager issues a control command indicating to permit the relay of a packet between identifier of the terminal that the user operates and identifier of the specific computer unit, to a hub that forms the network link between the network and each of the computer units.

16. The control server according to claim 15, wherein the control server is integrally configured with the hub.

17. The control server according to claim 13, wherein the link manager denies a login operation to a computer unit other than the specific computer unit to the terminal that the user operates.

18. In a computer system in which one or more computer units and one or more terminals are coupled via a network, a control server for controlling communication between the terminal and the computer unit,
wherein each of the computer units is coupled with a shared storage in which an available storage area is assigned to each user,
the control server comprising:
an authentication manager for authenticating the user to operate the terminal;
a computer unit manager for mounting the storage area within the storage assigned to the user, to any of the computer units in accordance with a result of the authentication; and
a link manager for setting a network link that enables communication between a terminal that the user operates and the mounted computer unit.

19. The control server according to claim 18,
the control server having a management database in which information on each user and information on the storage area within the storage that the each user can use are associated with each other and registered.

20. The control server according to claim 18,
wherein the computer unit manager mounts the storage area within the storage assigned to the user, in an available computer unit of the computer units.

21. The access control service according to claim 1,
wherein the computer units are a storage.

22. An access control service carrying out communication by connecting one or more terminals and a storage via a network to access from the terminal to the storage,
wherein the storage is a shared storage that is coupled to each of the terminals and has an available storage area assigned to each user,
the control service comprising:
a control server for authenticating the user to operate the terminal, mounting, in a terminal that the user operates, the storage area within the storage assigned to the user in accordance with a result of the authentication in the terminal the user operates, and setting a network link that enables communication between the terminal the user operates and the storage.

23. The access control service according to claim 22, wherein, in the control server, information on each user and information on the storage area within the storage that the each user can use are associated with each other and registered.

24. The access control service according to claim 1, wherein the control server monitors a communication status between the terminal and the computer unit, and releases the established network link when detecting a non-communication status.

25. The access control service according to claim 6, wherein the terminal monitors the communication status with the computer unit and releases the established network link when detecting a non-communication status.

26. In a computer system in which one or more terminals and a storage are coupled via a network, a control server for controlling communication between the terminal and the storage,
wherein the storage is a shared storage that is coupled with each of the terminals and has an available storage area assigned to each user,
the control server comprising:
an authentication manager for authenticating the user to operate the terminal;
a computer unit manager for mounting the storage area within the storage assigned to the user in accordance with a result of the authentication, in a terminal that the user operates; and
a link manager for setting a network link that enables the communication between the terminal that the user operates and the storage.

27. The control server according to claim 26, the control server having a management database in which information on each user and information on the storage area within the storage that the each user can use are associated with each other and registered.
